(19) United States
(12) Patent Application Publication
(10) Pub. No.: US 2008/0265702 A1
(43) Pub. Date: Oct. 30, 2008

(54) Permanent magnetic brushless motor with length adjustable air gap based on load

(76) Inventor: Don-Lon Yeh, Taichung Hsien (TW)

Correspondence Address: Don-Lon Yeh, 235 Chung - Ho, Box 8-24, Taipei, TW

(21) Appl. No.: 11/789,796

(22) Filed: Apr. 26, 2007

(51) Int. Cl. H02K 7/12

(52) U.S. Cl. 310/90; 310/152; 310/261; 310/156.32; 310/191

(57) ABSTRACT

A permanent magnetic brushless motor with a length adjustable air gap comprises: a body; a stator secured to one end of the body; a spindle pivotally installed to the body; a part of the spindle protruding from the body; a rotor being axially movable with respect to the spindle by using a sliding unit; the rotor being pivoted in the body and an air gap being formed between the rotor and the stator; a length of the air gap being adjustable; at least one connecting unit two ends of which are connected to the rotor and the spindle; the orientation of the connecting unit being changeable with the rotation angle between the rotor and the spindle; and an elastic unit capable of pushing the rotor to move away from the stator so that the connecting unit moves to a straight state. In the motor, the adjustment of the air gap is automatically performed during the operation of the motor without needing any manual action.

### FIELD OF THE INVENTION

The present invention relates to motors, and particularly to a permanent magnetic brushless motor with a length adjustable air gap based on a load, wherein the output of the motor is changeable without using any gearbox. The torsion and rotation speed of the motor are changeable. In the present invention, the adjustment of the air gap is automatically performed during the operation of the motor without needing any manual action.

### BACKGROUND OF THE INVENTION

In the design of a motor, the maximum torsion, maximum rotation speed, maximum power and maximum momentum must be taken into consideration. Thereby the maximum torsion and maximum rotation speed directly affect the load to be driven by the motor, and thus they are especially important. The following formula is used for these elements.

T=A×kt

Kt=(C×VD)/Nmax

T=(A×C×VD)/Nmax

wherein T: maximum torsion of the motor; Nmax: the maximum rotation speed; kt: motor torque coefficient; C: a constant of 9.55, VD=voltage at the motor end; and A=input current of motor.

In practice, the power supply of the motor must be matched. From above formula, it is known, when the voltage at the motor end (VD), and input current of motor (A) are retained, the maximum torsion T and the maximum rotation speed Nmax are inversely proportional. In the design of the motor, the maximum torsion and the maximum rotation speed must be compromised. Other than the voltage of the motor, the motor structure also affects the maximum torsion and maximum rotation speed, such as the magnetic property of the magnet of the motor rotor, the winding of the stator and the air gap between the stator and the rotor.

However, the structure of a motor is determined after it is manufactured, and it is not adjustable thereafter. Thereby it is impossible to consider a structure which achieves the maximum torsion and maximum rotation speed.

For example, for a permanent magnetic brushless motor, as shown in FIG. 7, it has a radial arranged air gap. The stator and rotor are designed so that one is at an inner side and the other is at an outer side. An air gap with a fixed size is retained between the stator and the rotor. The size of the stator is determined by the size of the rotor and thus it is unadjustable. Other factors such as the strength of the magnets, number of magnetic poles, number of windings are also unchanged. Thus in the prior art motor, a mechanical gearbox is used for adjusting the maximum torsion and maximum rotation speed.

However, the prior art gearbox still induces some problems, such as the increments of cost, volume, and weight of the gearbox. Thereby in energy transfer, the gearbox will cause that the energy decays in the transfer process. The gearbox also consume power which become heat and generates noises.

Moreover, if the motor is used to an electromotive car, other than the gearbox, a mechanical differential gear is used to control the rotation speed difference of the wheels in two sides of the car as the car changes its direction. As a result, the traveling distance of the car has a reduction of 40 to 50% so that the property of the car is deteriorated.

Thus from above discussion, it is known that in the design of a motor, the maximum torsion and maximum rotation speed must be compromised as the power supply is constant. However, the prior art motor has fixed maximum torsion and maximum rotation speed and thus a gear must be used, while this induces the problems of the increments of cost, volume, and weight of the gearbox.

### SUMMARY OF THE INVENTION

Accordingly, the primary object of the present invention is to provide a permanent magnetic brushless motor with a length adjustable air gap based on a load, wherein the output of the motor is changeable without using any gearbox. The torsion and rotation speed of the motor are changeable.

Another object of the present invention is to provide a permanent magnetic brushless motor with a length adjustable air gap, in that, the adjustment of the air gap is automatically performed during the operation of the motor without needing any manual action.

To achieve above objects, the present invention provides a permanent magnetic brushless motor with a length adjustable air gap based on a load, comprising: a body; a stator secured to one end of the body; a spindle pivotally installed to the body; a part of the spindle protruding from the body; a rotor being axially movable with respect to the spindle by using a sliding unit; the rotor being pivoted in the body and an air gap being formed between the rotor and the stator; a length of the air gap being adjustable; at least one connecting unit two ends of which are connected to the rotor and the spindle; the orientation of the connecting unit being changeable with the rotation angle between the rotor and the spindle; and an elastic unit capable of pushing the rotor to move away from the stator so that the connecting unit moves to a straight state. When a load of the spindle changes, the with respect to angle between the rotor and the spindle changed so as to change the inclination of the connecting unit and thus the rotor moves axially to change a length of the air gap.

The length of the air gap is determined by the resisting force of the spindle, namely based on the load of the spindle. The greater the load of the spindle, the greater the rotation angle of the spindle. The connecting unit will be inclined with a great extent. Therefore, the rotor is driven by the connecting unit to move axially toward the stator so as to reduce the length of the air gap. The motor with a small length of the air gap has a property of large torsion and lower rotation speed. On the contrary, the smaller the load of the spindle, the smaller the rotation angle of the spindle. The connecting unit will be straight with a great extent. Therefore, the rotor is driven by the connecting unit 14 to move axially away from the stator so as to increase the length of the air gap. The motor with a small length of the air gap 16 has a property of small torsion and high rotation speed.

The present invention provides a permanent magnetic brushless motor by the size of the load. Thus, the present invention is suitable for high rotation speed devices which can adjust the torsion and the rotation speed automatically according to the load. For example, for electromotive vehicles, the length of the air gap 16 is determined by the resisting force of the load of the spindle 12. For a heavy load, the air gap 16 of the body 1 will reduce for providing a greater torsion. On the contrary, when the load of the electromotive vehicle is light, the length of the air gap 16 of the body 1 is increased so as to provide a greater rotation speed. Therefore, no gear box is necessary and the energy consumption of the body 1 of the motor is reduced.

Advantage of the present invention is that the adjustment of the air gap is automatically performed during the operation of the motor without needing any manual action.

The various objects and advantages of the present invention will be more readily understood from the following detailed description when read in conjunction with the appended drawing.

### BRIEF DESCRIPTION OF THE DRAWINGS

FIG. 1 is a schematic cross sectional view showing that the air gap is greater.

FIG. 2 is a schematic view showing that the air gap is smaller.

FIG. 3 is a table showing the characteristic curve with the relations to the attraction force of the magnet and the length of the air gap.

FIGS. 4 to 6 shows the variations of the rotor, spindle and the connecting unit.

FIG. 7 is a schematic view about the prior art motor.

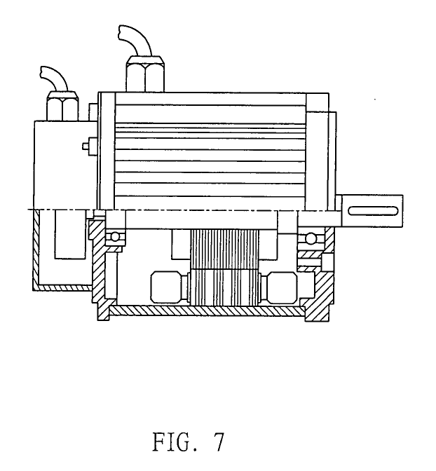

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

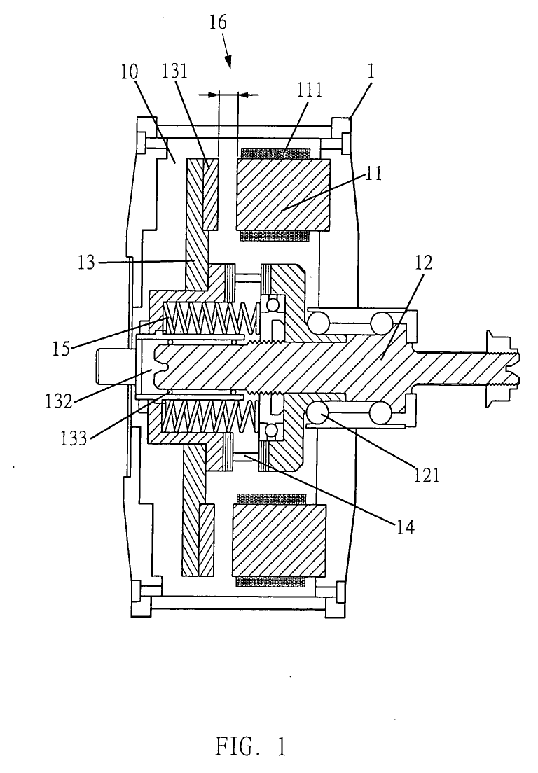

Referring to FIG. 1, the structure of the present invention is illustrated. The present invention has the following elements.

A body 1 has a receiving space 10 therein.

A stator 11 is a multiple pole annular silicon sheet and is installed at one end of the receiving space 10 of the body 1. A plurality of copper conductor wires are wound on the stator 11 to be formed as a plurality of coil sets 111. When the coil sets 111 are conducted, it will generate magnetic force.

A spindle 12 is pivoted to the body 1 by using a bearing set 121 (including a plurality of bearings). A part of the spindle 12 protrudes from the receiving space 10 of the body 1 for being connected to a load and driving the load.

A rotor 13 is a multiple annular structure. The rotor 13 is installed with a plurality of magnets 131. The magnets 131 of the rotor 13 are retained with a space to the stator 11. The space is called as air gap 16. In the design of the present invention, the length of the air gap 16 is changeable. A center of the rotor 13 is formed with a sliding groove 132 for receiving one end of the spindle 12. A ball like or annular-formed sliding unit 133 is installed between a wall of the sliding groove 132 and the spindle 12 so that the rotor 13 is movable along the spindle 12.

At least one connecting unit 14 has two ends which are pivoted to the rotor 13 and the spindle 12, respectively. In the present invention, a plurality of connecting units 14 are permissible. The connecting unit 14 serves to combine the rotor 13 and the spindle 12. The connecting unit 14 may have a rod shape or a ring shape. When a torsion is generated between the rotor 13 and the spindle 12 so that the rotor 13 rotates with respect to the spindle 12, the connecting unit 14 will incline due to the torsion. The rotor 13 will move axially along the sliding groove 132. When the torsion is balance between the rotor 13 and the spindle 12, the rotor 13 will drive the spindle 12 through the connecting unit 14.

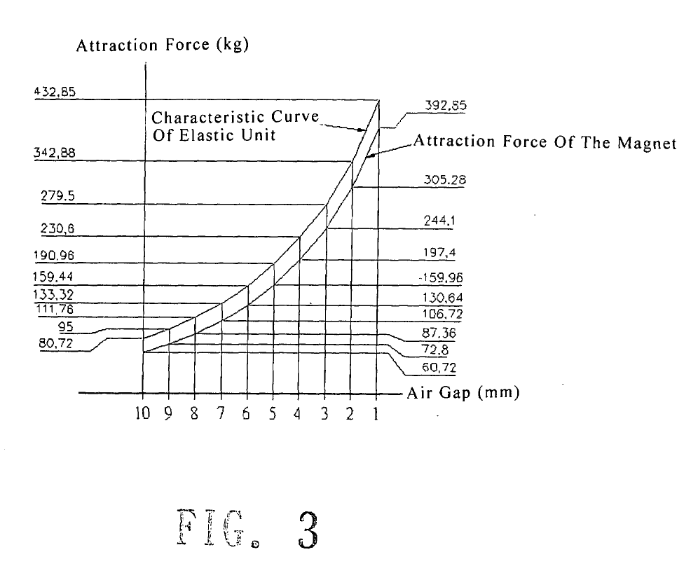

An elastic unit 15 is installed between the rotor 13 and the spindle 12. The elastic unit 15 will push the rotor 13 to move away from the stator 11 so that the connecting unit 14 is placed in a straight position. The elastic force provided by the elastic unit 15 is slightly greater the attraction force between the magnets 131 of the rotor 13 and the stator 11. The characteristic curve of the elastic unit 15 is as that illustrated in FIG. 3.

In FIG. 3, a magnet object with a thickness of 8 mm is used as a test object. The relations between the attraction force of the magnet object (longitudinal axle, with a unit of Kg), the elastic force of the elastic unit (also represented in the longitudinal axle, with a unit of Kg) and the air gap (transversal axle with a unit of mm). The attraction force of the magnet is inversely proportional to the square of the length of the air gap 16. When the air gap 16 is reduced, the attraction force will enhance. If the length of the air gap 16 is increased, the attraction force will weaken. For the elastic unit 15, when the air gap 16 reduces, the elastic unit 15 has a greater deformation, so that the elastic unit 15 provides a great elastic force to the rotor 13. The elastic force of the elastic unit 15 is inversely proportionally to the square of the length of the air gap 16. Therefore, the attraction force of the air gap 16 represented in the transverse axle has a variation corresponding to the elastic force of the elastic unit 15. The elastic force of the elastic unit 15 cause the rotor 13 to move away from the rotor 13. The magnet 131 has an inverse effect, which makes the rotor 13 move closer to the stator 11. Therefore, in selection of the elastic unit 15, the elastic force of the elastic unit 15 must be slightly greater than the attraction force of each magnet instead of the length of the air gap. Thus the characteristic curve of the elastic coefficients of the elastic unit 15 must be properly selected to match this requirement. Thereby the rotor 13 and stator 11 can be adhered completely and the connecting unit 14 is straight.

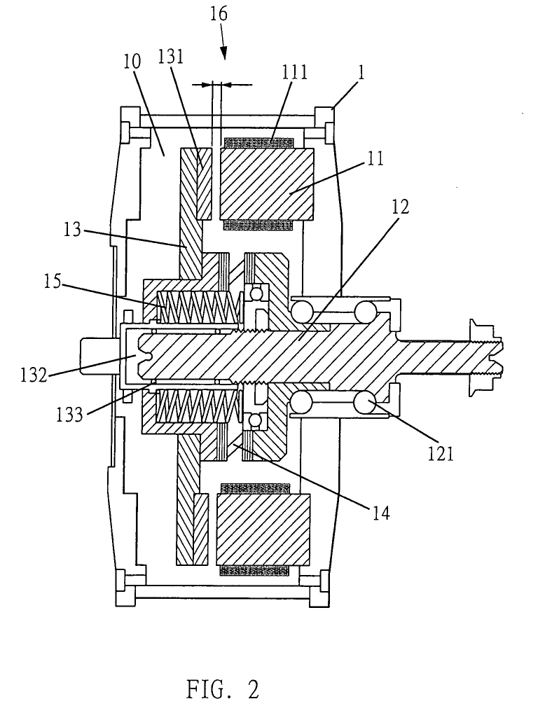

In use of the present invention, when the coil sets 111 of the stator 11 are conductive, the silicon steel sheets of the stator 11 generate electric magnetic force so as to attract or repulse the magnets 131 of the rotor 13 to drive the rotor 13 to rotate. However, due to the resist force from the external load, the spindle 12 of the motor will not rotate. Thus the stator 11 and the spindle 12 rotate slightly. The connecting unit 14 between the rotor 13 and the spindle 12 will incline to overcome the pushing force of the elastic unit 15. Thus the magnets 131 of the rotor 13 will move closer to the stator 11 so as to reduce the length of the air gap 16, as shown in FIG. 2. When the resisting force of the load of the spindle 12 is reduced, the elastic unit 15 will push the rotor 13 to move away from the stator 11. Thereby the rotor 13 will return to the state illustrated in FIG. 1.

The length of the air gap 16 is determined by the resisting force of the spindle 12, namely based on the load of the spindle 12. The greater the load of the spindle 12, the greater the rotation angle of the spindle 12. The connecting unit 14 will incline with a great extent. Therefore, the rotor 13 is driven by the connecting unit 14 to move axially toward the stator 11 so as to reduce the length of the air gap 16. The motor with a small length of the air gap 16 has a property of large torsion and lower rotation speed.

On the contrary, the smaller the load of the spindle 12, the smaller the rotation angle of the spindle 12. The connecting unit 14 will be straight with a great extent. Therefore, the rotor 13 is driven by the connecting unit 14 to move axially away from the stator 11 so as to increase the length of the air gap 16. The motor with a small length of the air gap 16 has a property of small torsion and high rotation speed.

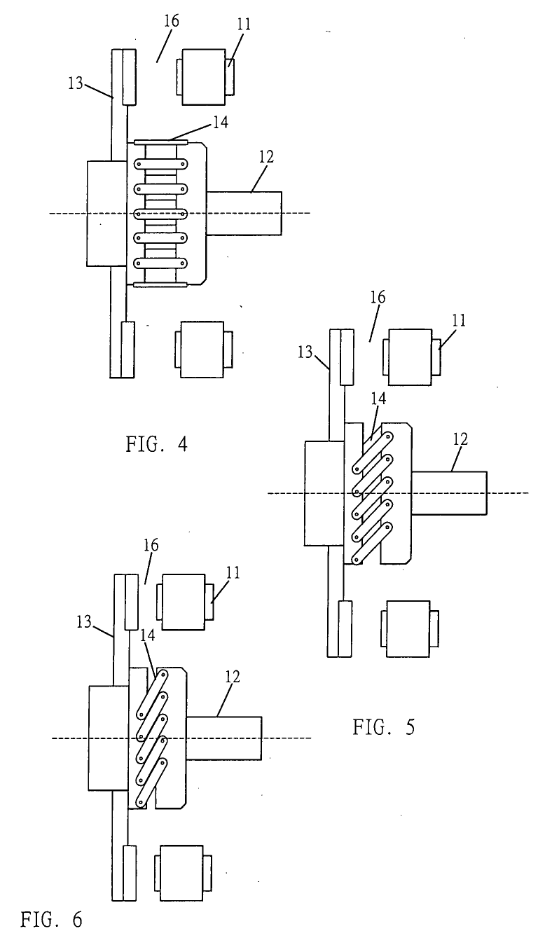

The relation of the rotor 13, spindle 12 and connecting unit 14 is illustrated in FIGS. 4 to 6.

As illustrated in FIG. 4, when it is not used or the load is small, the resisting force suffered by the spindle 12 is small, the rotate angle between the rotor 13 and the spindle 12 is small, the connecting unit 14 is straight. Thus, the rotor 13 do not move closer thereto so as to have a greater air gap 16 and thus the rotation speed is greater and the torsion is small.

As shown in FIG. 5, when the load is greater, the resisting force applied to the spindle 12 is increased, the difference of the torsion between the rotor 13 and the spindle 12 will make the rotate angle increase. The connecting unit 14 will incline. Then the rotor 13 is pulled by the connecting unit 14. The air gap 16 is smaller and the torsion of the body 1 increases so as to reduce the rotation speed.

Referring to FIG. 6, when the load is greater, the connecting unit 14 will incline, and the air gap 16 becomes smaller. Thus it generates a high torsion and has a low rotation speed.

The present invention provides a permanent magnetic brushless motor by the size of the load. Thus, the present invention is suitable for high rotation speed devices which can adjust the torsion and the rotation speed automatically according to the load. For example, for electromotive vehicles, the length of the air gap 16 is determined by the resisting force of the load of the spindle 12. For a heavy load, the air gap 16 of the body 1 will reduce for providing a greater torsion. On the contrary, when the load of the electromotive vehicle is light, the length of the air gap 16 of the body 1 is increased so as to provide a greater rotation speed. Therefore, no gearbox is necessary and the energy consumption of the body 1 of the motor is reduced.

Advantage of the present invention is that the adjustment of the air gap is automatically performed during the operation of the motor without needing any manual action.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A permanent magnetic brushless motor with a length adjustable air gap based on a load, comprising:
a body;
a stator secured to one end of the body;
a spindle pivotally installed to the body; a part of the spindle protruding from the body;
a rotor being axially movable with respect to the spindle by using a sliding unit; the rotor being pivoted in the body and an air gap being formed between the rotor and the stator; a length of the air gap being adjustable;
at least one connecting unit two ends of which are connected to the rotor and the spindle; the orientation of the connecting unit being changeable with the rotation angle between the rotor and the spindle; and
an elastic unit capable of pushing the rotor to move away from the stator so that the connecting unit moves to a straight state; and
wherein when a load of the spindle changes, the rotation angle between the rotor and the spindle changes so as to change the inclination of the connecting unit and thus the rotor moves axially to change a length of the air gap.

2. The permanent magnetic brushless motor with a length adjustable air gap based on a load as claimed in claim 1, wherein a sliding groove is formed in the rotor for installing the sliding unit and the spindle.

3. The permanent magnetic brushless motor with a length adjustable air gap based on a load as claimed in claim 1, wherein the elastic unit resists against the spindle and the rotor.

4. The permanent magnetic brushless motor with a length adjustable air gap based on a load as claimed in claim 1, wherein more than one connecting unit are installed.

5. The permanent magnetic brushless motor with a length adjustable air gap based on a load comprising:
a body;
a stator being a multiple pole annular silicon sheet and being installed at one end of the receiving space of the body; a plurality of copper conductor wires are wound on the stator to be formed as a plurality of coil sets; when the coil sets are conducted, the stator will generate magnetic force;
a spindle pivoted to the body by using a bearing set; a part of the spindle protruding from the receiving space of the body for being connected to a load and driving the load;
a rotor being a multiple annular structure; the rotor being installed with a plurality of magnets; the magnets of the rotor being retained with a space to the stator as an air gap; the length of the air gap being changeable; a center of the rotor being formed with a sliding groove for receiving one end of the spindle; a ball like or annular form sliding unit being installed between a wall of the sliding groove and the spindle so that the rotor is movable along the spindle;
at least one connecting unit having two ends which are pivoted to the rotor and the spindle, respectively; the connecting unit serving for combining the rotor and the spindle; when a torsion is formed between the rotor and the spindle so that the rotor rotates with respect to the spindle, the connecting unit will incline due to the torsion; the rotor will move axially along the sliding groove; when the torsion is balance between the rotor and the spindle, the rotor will drive the spindle through the connecting unit; and
an elastic unit installed between the rotor and the spindle; the elastic unit will push the rotor to move away from the stator so that the connecting unit is placed in a straight position; the elastic force provided by the elastic unit is slightly greater the attraction force between the magnets of the rotor and the stator; the characteristic curve of the elastic unit.
